(19) United States
(12) Patent Application Publication
(10) Pub. No.: US 2024/0181734 A1
(43) Pub. Date: Jun. 6, 2024

(54) Method for Creating and Verifying a Program for Controlling the Components of a Multi-Plate Powder Press Using Numerical Control

(71) Applicant: Osterwalder AG, Lyss (CH)

(72) Inventors: Peter Kunz, Aegerten (CH); Reto Kühni, Rüfenacht (CH)

(21) Appl. No.: 18/285,399

(22) PCT Filed: Mar. 25, 2022
(86) PCT No.: PCT/EP2022/057902

§ 371 Date: Oct. 3, 2023

(30) Foreign Application Priority Data
Apr. 6, 2021 (EP) 21166942.9

(51) Int. Cl. B30B 9/28; B22F 3/03; B28B 3/04; B28B 17/00; B30B 15/00

(52) U.S. Cl. CPC B30B 9/28; B22F 3/03; B28B 3/04; B28B 17/0081; B30B 15/0041; B22F 2003/031; B22F 2203/00

(57) ABSTRACT

Multi-plate powder press (100) for producing a dimensionally accurate pressed part from a compressible material which is fillable into a die (2), having a punching device (3) comprising a multitude of punches (6) and components adjustable relative to one another in the axial direction and adjustable relative to a press part, a drive unit for adjusting the punching device (3) and/or the punches (6) and components, adjustable relative to one another, in and/or counter to a pressing direction, and a numerical control device which is set up and is programmable in order to control a movement sequence of the punching device and/or the punches and components, adjustable relative to one another, in accordance with a control program. The multi-plate powder press (100) has a control command input element for inputting control parameters and has a display element in order to graphically display the punching device (3) and/or the punches (6) and components, adjustable relative to one another, and also movement sequences. Furthermore, a method for controlling the multi-plate powder press (100) is provided.

### TECHNICAL FIELD OF THE INVENTION

The present invention relates to a method for creating and verifying a program for controlling the components of a multi-plate powder press using numerical control. More specifically, the numerical control of a machine tool designed as a multi-plate powder press uses machining software, which is then transmitted to the multi-plate machine tool for execution. In addition, the present invention also relates to a device for implementing this method, as well as a digital control system.

### STATE OF THE ART

It is generally known that modern machine tools are controlled by numerical control (NC). Up to now, for hydraulic or mechanical powder presses, CNC programming for parallel control of a large number of controllable tooling devices, based on a sequence plan for a press stroke during a press cycle, is known, but still needs to be improved. In particular, effects occurring during pressing and the complex movement sequences of the individual axes in relation to each other cause problems during programming.

In general, powder presses for the production of dimensionally accurate pressed parts from a compressible material comprise a press frame, a die or die arrangement with a die opening defining a die cavity, at least one upper punch or upper punch arrangement and/or at least one lower punch or lower punch arrangement and adjustment drives or drive systems for upper and/or lower punches and/or the die, which are guided along guides. Punch and die are movable relative to each other along a press stroke axis and can be pressed against each other. In addition to a linear movement, it may be possible for single or multiple axes or punches and/or dies to perform a rotational movement synchronously with the stroke movement. This is provided, for example, in the production of helical-toothed pressed parts. Powder presses can be divided into different types, for example with regard to their drive system, i.e., into hydraulic, electric and hybrid presses. Furthermore, ceramic and/or metal powder presses are also known, in which a transverse punch arrangement is arranged perpendicular to a main pressing direction for pressing and/or forming the pressed part perpendicular to the compaction axis.

In the production of a multi-stage pressed part, an independently movable so-called tool level is required for almost every component height, on which tool-specific elements can be built up to form a tool. Punches are also referred to as tools which, for example, are moved linearly and rotationally at a defined speed, in particular in a controlled manner, and apply a controlled, in particular a feedback-controlled force, in order to press a pressed part from powder or granulate to a predefined pressed part size. The punch or the tool is arranged on a punch or tool carrier. These carriers can be designed as plates or also as pots and can be moved by the drive system, guided relative to a base body or a base plate in the powder press, directly or by means of adaptors, whereby the individual punches are moved relative to each other at different speeds and/or stroke distances or stroke paths. The distances of movement of the individual punches and their adjusting components are also referred to as axes. Furthermore, in powder presses, especially in hydraulic powder presses, support devices are provided, which support the punches in the press end position relative to the base body. For this purpose, stops in the form of mechanical fixed stops can be provided which can be adjusted relative to the base body or a base plate and are set up in such a way that a pressing force in the press end position is at least partially diverted into the base body or base plate. Furthermore, today's press equipment includes measuring systems with sensors, for example to determine the positions of the tools.

The pressing process, which can be subdivided into several process stages, for producing a multi-stage pressed part comprises filling the pressable material into the die, into which, for example, the plurality of lower press tools have already been inserted and pre-positioned relative to one another. The positions of the plurality of lower punches, also referred to as the filling position, determine the amount of pressable material that can be filled into the die. This is followed by a stage known as powder transfer, in which the filled powder is displaced without compaction by an individual punch movement of the upper and/or lower punches inserted into the die, until an unpressed part contour of the pressed part to be achieved is filled uniformly and in such a way that the pressed part has a uniform density distribution. The actual pressing process takes place under consideration of pressing parameters such as time, distance, and force, whereby the multitude of pressing tools are moved into their final pressing position. This is followed by the steps for releasing the pressure, removing the pressing tools and exposing the pressed part.

For standardization, automation and/or simplification in the systematic execution of process steps in the manufacture of a product, using the example of a stepped complex pressed part in a multi-plate powder press, there is a need for computer-controlled support of an operator by means of a control program. This is particularly important since, with known control systems, individual settings must be entered by an operator for individual tools.

For the creation and verification of a control program for a press device, it is known to carry out a first stroke or test stroke to determine whether the programming in the machine-readable program code has been carried out correctly. A subsequent correction during such a test stroke is often not possible, so that tool breakages can also occur, and several test strokes are required after previous corrections.

From EP 1 439 949 a ceramic or metal powder press is known, which has a special software for the simulation of a test stroke, so that collisions and errors in the coded program can be detected. Such software is expensive, and the simulation can slow down the whole process. The simulation is based on a plan for a press stroke of a press cycle, whereby target values of the parameters of the tooling equipment are determined and a coded control program is created, which is subsequently checked by means of a simulation running on a computer device.

From DE 10 2010 044 688 a control method is known for a metal or ceramic powder press or a press tool of such a press with a punching device and a drive system designed as a spindle drive, whereby a control device after programming of control parameters simulates a first “test stroke”, which can be interrupted and which can be controlled and adjusted step by step by means of a manual control component, which is designed and programmable in connection with the control device. The manual control component can be an electric feeler or a handwheel that emits an adjustment or control signal per press, whereby the control device triggers or controls a step-by-step movement of adjustable components of the press by means of the signals.

The object of the present invention is to provide a multi-plate powder press and a method for controlling, in particular feedback controlling, the same, whereby setting and verification of control parameters or feedback control parameters and of a control program that can be created is possible in a simple and safe manner. In particular, this should be possible without having to interrupt the current pressing process. Accordingly, readjustments due to thermal effects can also be largely avoided. Furthermore, simple operability and a connection to higher-level company and production systems should be provided. Customization and universal extension of the process to different types of powder presses should be ensured, as well as management, documentation and visualization of order, process and machine data.

### SUMMARY OF INVENTION

The present invention therefore provides a multi-plate powder press with a simple and efficient means of creating programs for controlling the components of the multi-plate powder press using a numerical control device, which are digitally checked for accuracy and feasibility prior to execution by the control device, and which are directly modifiable via input means. This can be done advantageously during a running operation of the press, whereby individual parameters can be changed and immediately adopted for a next stroke, so that a stable production can be ensured. In this way, short downtimes of the multi-plate powder press can be avoided, so that thermal influences due to a temperature change of the punches, etc., occurring during downtime, can also be avoided. Furthermore, it is not necessary to interrupt a continuous powder flow for a transmission of the control program.

To this end, the present invention relates to a multi-plate powder press having a numerical control device according to claim 1 and a method of controlling such a multi-plate powder press according to claim 6.

Accordingly, the invention relates to a multi-plate powder press for the production of a dimensionally accurate pressed part of a compressible material, which can be filled into a die, with a punching device comprising a plurality of punches and components which are adjustable in an axial direction and rotationally relative to one another and which are adjustable relative to a press part, with a drive unit for adjusting the punching device and/or the punches and components adjustable relative to one another in and/or against a pressing direction, and a numerical control device which is set up and programmable in order to control, in particular to feedback control, a movement sequence of the punching device and/or the punches and components adjustable relative to one another in accordance with a control program. Furthermore, a control command input element for the input of control parameters and a display element are provided to graphically display the punching device and/or the punches and components adjustable in a way relative to one another as well as movement sequences.

In the sense of the invention, a multi-plate powder press comprises a punching device which includes a plurality of controllable components. Controllable components are understood to be adjustable punches or tools as well as components that are adjustable relative to one another, such as punch carriers, adjustable fixed stops and/or a die arrangement. At least one punching device is provided with a plurality of tools or punches and components arranged below and/or above a die arrangement, which can be adjusted relative to one another in the axial and possibly in the rotational direction by means of a drive system, so that a powdered and/or granular material filled into the die arrangement is able to be pressed into a dimensionally accurate, in particular multi-stage, pressed part. Furthermore, a numerical control device is provided, which is configurable and programmable. Provided is a control command input element to provide a possibility for a user to directly influence the creation of a control program by entering control parameters, whereby a simple and understandable graphical display is provided on a display element. The inputs relate, for example, to the number and geometric shape of the adjustable punches, their arrangement, the punch travel or stroke distance of the individual punches, as well as force-path characteristics of the axes involved. Furthermore, data relating to the pressing process, tools and/or product parameters such as physical characteristics of the material to be pressed, tolerances and/or a desired density distribution in the pressed part to be produced can be entered or read in from an associated data memory.

According to one embodiment of the invention, provided for interaction with a user of a multi-plate powder press is an interface in the form of a screen of a computer, of a touch screen tablet or even of a smartphone. A user concept realized in this way is supported by a multiplicity of operating displays, dialogues, and messages. By means of an interface for interaction with the user, the user can input commands into the control program to be created, delete commands from the control program or carry out another adjustment of the control program.

According to one embodiment of the invention, further provided is an element for wireless transmission of the created control program to the numerical control device. The numerical control device is set up to control, in particular to feedback control, the control program to execute the punching device of the multi-plate powder press and/or the punches and components adjustable relative to one another.

The proposed solution is characterized by a definition of a series of control parameters including defined movements of the controllable components of the multi-plate powder press, which are required for the press operation or respectively press cycle, and through the creation of a control program, comprising a series of commands, each command corresponding to a movement of the defined components of the multi-plate powder press, analyzing the commands of the generated control program and performing calculations of the movements of the components of the multi-plate powder press to determine the parameters and sequences of movements during the pressing operation. Then and prior to the transmission of the control program to the numerical control device, parameters and a sequence of courses of movement of the controllable components are displayed graphically in real time in a way conforming to reality.

According to the invention, a method for controlling the previously described multi-plate powder press is provided, which, among other things, achieves an analysis of the commands of the control program, an execution of the calculation of the control parameters and a movement of the controllable components of the multi-plate powder press as well as a display of the sequence of courses of movement of the press operation, in particular subdivided per encompassed process step of the multi-step process sequence, in real time. An initial examination of a determined pressing sequence and of the correspondingly carried out programming is thus possible. In addition, a display takes place of the press sequence using easily comprehensible graphics showing a realistic but abstract representation of the punch, punch carrier, fixed stops and further adjustable components.

In one embodiment of the method, it is therefore possible for the user of the multi-plate powder press or a programmer to easily check the control program on the basis of the paths of the tools, i.e. the plurality of lower punches and the plurality of upper punches and other components, during the individual process stages of the pressing operation and to immediately detect collisions of individual components with one another and errors that can negatively influence the execution of the control program and this also without using additional software for a plausibility check or a simulation. Since the movements of the tools are calculated in real time and then immediately displayed graphically, the check of the control program can be performed almost in parallel with the programming.

It is intended that certain configurations are entered by the user and displayed to him in a simple graphical display. In this way, information on the lower tools, i.e., the plurality of lower punches and/or the upper tools, i.e., the plurality of upper punches, as well as on components such as fixed stops can be entered via a prepared mask. In addition to the number and arrangement, the information can also include the shape of the punches, i.e., whether they have a flat or stepped punch surface and which punches and/or other components are arranged adjacent to each other.

Furthermore, inputs can be made for the pressed part to be produced, which relate in particular to the pressed part heights to be achieved between opposing punches. The stroke path of individual punches can be displayed graphically, in particular in relation to a reference line to be defined. Through color-contrasted tools, a clear representation of the tool properties is displayed.

In the context of a simulation, the graphical representation of the arrangement of the individual tools and their traversable paths during the successive process steps of the pressing operation offers an optimal instrument for monitoring. By means of a representation of the time sequences of a pressing process for the production of a dimensionally accurate pressed part in the simulation, which is easy to capture, corrections to the settings can be made by direct access on the part of the user even during the ongoing pressing process, so that inaccuracies can be eliminated and/or settings can be made for optimization before the pressing process is carried out.

The graphical display on the display element uses a simple representation of the plurality of controllable components, e.g., the punches, and the surrounding die, for example the punches are represented as vertical bars which move in real time according to the real punches. The program offers the possibility to display a scaled-up and/or scaled-down representation according to the size of the part or pressed part to be produced, in order to include all punches, further components and their movements in one representation.

When the control program has been generated to satisfaction, it can be transmitted to the numerical control device, which executes it in order to control, in particular feedback control, the controllable components of the multi-plate powder press with the aim of producing a dimensionally accurate, in particular multi-stage pressed part. The generated control program can also be transmitted during the pressing process so that no time interruption can negatively influence the pressing process.

The starting point of the graphically representable process sequence is a basic state existing at the start time, in which in particular the multiplicity of punches are located outside the die.

To define a reference line for the tools or punches involved, a zero point for the tools or punches relative to their stop can be set in one step. For example, the plurality of lower punches is positioned relative to the die and the zero point is automatically set if a drag distance is less than or equal to an adjustable value. In the case of positioning, a drag distance is understood to be the difference between a desired value as a set value and a feedback actual value. Here, further corrections are possible if there is a deviation of a real tool or punch length from the theoretical one. An alternative for setting the zero point is, starting from a defined zero point of one of the tools, for example an outermost tool, that the zero point of the die is calculated. Based on the calculation of the zero point of the die, the positions of punch supports are automatically defined taking into account the real punch length.

After the process parameters and the reference line have been determined, the process steps of a pressing operation can be graphically displayed in a “simulation” program step. The simulation is based on the control program and a resulting calculation of the movement sequences. Preferably, the process procedure is divided into process stages, which can be represented individually, in particular divided into start position, filling, introduction, powder distribution first without pressing force effect, pressing, pressing force relief, uncovering and end. In the graphic representation of the start position, the individual tools of a lower punching device are inserted into the die and determine with the die the filling level or the filling volume of the material to be filled and pressed. Subsequently, positioned upper punches are displayed, whereby a certain up and down movement of the punches can be simulated in order to achieve a uniform distribution of the filled material to be pressed into the desired geometry and thus a uniform density of the pressed part. This process stage is also referred to as powder transfer. The actual pressing process is followed by process stages such as force relief or force reduction, as well as removal of the individual tools and, preferably in stages, uncovering of the pressed part, whereby the tools including the die return to the basic position. Since the movement of the individual components is calculated in real time and displayed directly, a nearly parallel correction can be carried out in the individual process stages by means of a direct access of the user via the control command input element to the control program.

According to one embodiment, the control method, in particular the closed-loop control method, comprises optimization of the pressing process, since there is a fundamental need for exact shape contour and dimensional accuracy during pressing in order to largely reduce or preferably avoid post-processing steps on the manufactured pressed part. Here, the graphic simulation according to the invention supports the user, for example, in recognizing crack formation and avoiding it.

By means of easily understandable and operable programming applications, actual/setpoint value real-time analyses, error displays and diagnostic functions can be made available within the scope of the invention. Thus, the produced pressed part can be measured, whereby references are advantageously freely selectable. In a graphical representation of the pressed part, the nominal values or the target values from the stored data can then be compared with the specific current values, the actual values. If there is an intolerable deviation between the nominal and actual values, a correction can be initiated by means of the method, which causes a change in the control program and thus a change in the control parameters, or respectively feedback control parameters, of the adjustable tools. One embodiment of the method provides that the measured values, i.e., the actual values, can be entered directly by the user at the control command input element without conversion or indication of signs, whereby these are automatically included correctly in the calculation. Other parameters to be determined are weight and/or partial densities of the pressed part, which are related to a new fill level to be determined and thus cause an automatic or manual adjustment of the control program.

According to one embodiment of the invention, the method for controlling or respectively feedback controlling a multi-plate powder press using a numerical control device comprises, after analysis of actual/target values and calculation for verification of correction values, a display for graphical visualization of how the density distribution in the pressed article to be produced changes due to changed process parameters. In particular, colors or distinguishable areas indicate whether the density in the section is increasing or decreasing and how it relates to the limit value. In addition, the direction in which the position of individual tools is changed can also be displayed.

An embodiment of the invention is explained in more detail below with reference to drawings. Shown are:

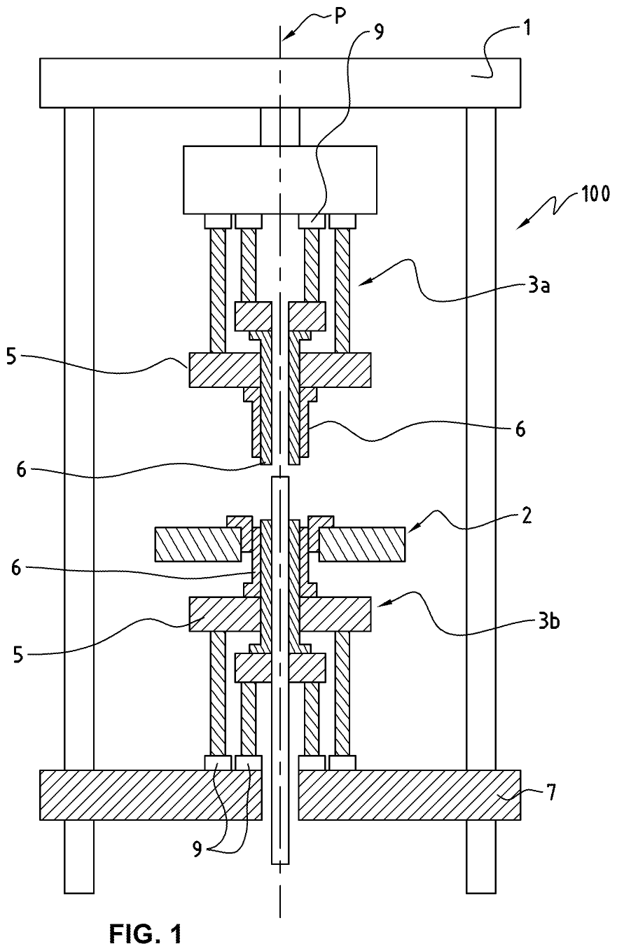

FIG. 1, a schematic simplified representation of a multi-plate powder press with a punching device and a die arrangement;

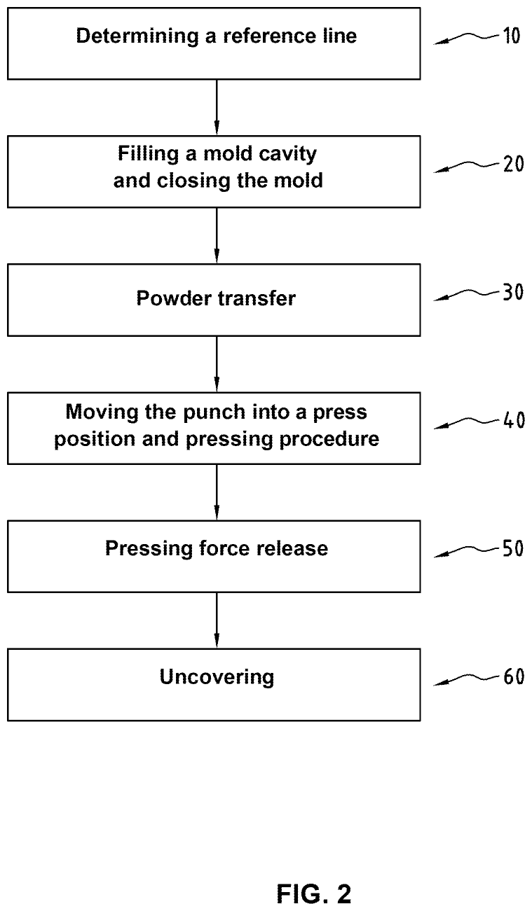

FIG. 2, a schematic diagram of a process for the production of a dimensionally accurate pressed part in a multi-plate powder press according to FIG. 1;

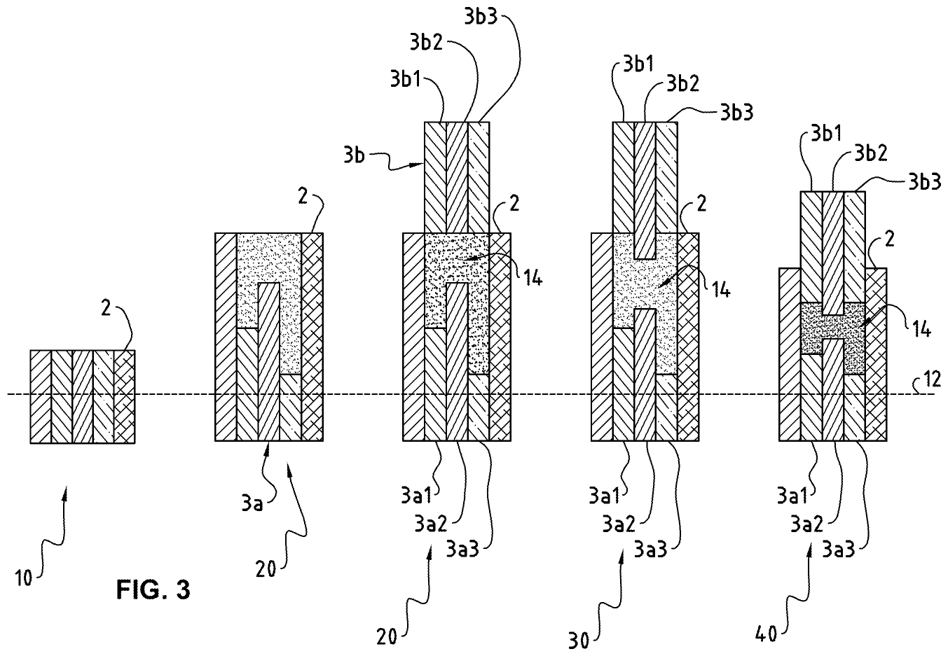

FIG. 3, a schematic representation of the punching device and the die arrangement during individual process stages in the production of a dimensionally accurate pressed part in the multi-plate powder press, which are displayed according to the method according to the invention;

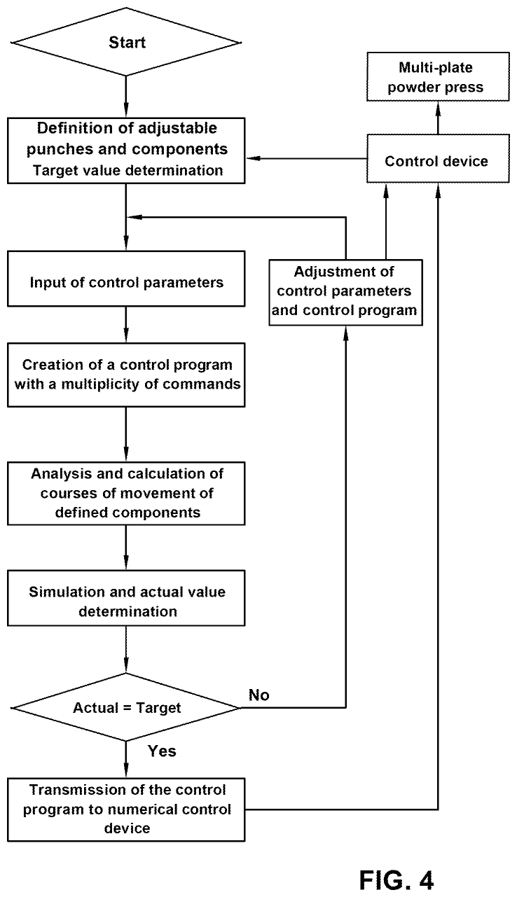

FIG. 4, a schematic flow chart of the method according to the invention for controlling a multi-plate powder press.

### DETAILED DESCRIPTION OF A PREFERRED EMBODIMENT

Shown in FIG. 1 is a schematic diagram of a multi-plate powder press 100, which has a multiplicity of moving components and tools. For simplicity, actuators, e.g., electric drives and/or hydraulic cylinders, for adjusting the punch arrangements, are not shown in this schematic representation. The multi-plate powder press 100 has a frame structure 1 with an upper punch arrangement 3a, a lower punch arrangement 3b, collectively referred to as punching device 3, and a die arrangement 2. The punch arrangements 3a, 3b can comprise a plurality of punch carriers 5 which are movably mounted, for example, on a base plate 7, wherein adjustable punches 6 and components, for example adjustable fixed stops 9 or other movable elements, are supported on the base plate 7 and on individual punch carriers 5, which are moved rotationally along a pressing axis P and/or by means of a drive system (not shown) for pressing a compressible material. Depending on the complexity of a tool, a large number of adjustable components of the tool are to be controlled relative to one another.

The multi-plate powder press 100 comprises a numerical control device, which is set up and programmable in order to control, in particular to feedback control, in accordance with a control program, a movement sequence of the punching device and/or the punches 6 and components, adjustable relative to one another. Furthermore, a control command input element is provided, by means of which control parameters are able to be entered, and a display element in order to portray graphically the punching device 3 and/or the punching device and/or the punches 6 and components, adjustable relative to one another as well as movement sequences.

Shown in FIG. 2 is the process sequence for the manufacture of a dimensionally stable pressed part from a compressible material, comprising several stages. A stage 10 comprises establishing a so-called reference line or zero point for the punches 6 involved in the pressing operation, this having to be done once during set-up. To establish the reference line, for example, each of the plurality of lower punches 3a can be positioned relative to the die 2, the zero point being established when a difference between an actual value to be determined and confirmed and a predefined set value is smaller than a predeterminable value. This value is also referred to as the drag distance. Practically, this can be done by moving each of the plurality of lower punches 3a, which rest on or against their stops, downwards until the drag distance is, for example, 2 mm, so that the zero point is set for this axis.

If the respective zero point is already known, then each punch 3a, 3b can be moved to its zero point and any differences, e.g., excess length, can be measured and used to correct the zero point. This avoids errors in the case that the punch length does not correspond to the theoretical dimension and allows an adjustment of the punch carrier taking into account the actual punch length.

In a subsequent step 20, the lower punch assembly 3a and the die assembly 2 move to a filling position in which a mold cavity 14 is filled with the compressible material, and the upper punch assembly 3b moves to a position in which the mold is closed. The punch arrangements 3a, 3b then move into the filled mold cavity in stage 30 without compressing the filled powder. Preferably, the individual punches 6 can be moved up and down to a certain extent, so that the powder is distributed evenly and optimally for a density distribution of the pressed part to be achieved. In this stage 30, also called powder transfer, no pressing force is applied.

In a further stage 40, the punches 6 are then moved into their end positions by means of the drive systems of the multi-plate powder press 100 and the powder in the mold cavity 14 is pressed, i.e., compacted into a dimensionally accurate pressed part, whereby a certain holding time can also be observed. Then, in a step 50, the pressing force is relieved and then, according to step 60, the die arrangement 2 and/or the respective punches 6 of the punch arrangements 3a, 3b are moved, the latter preferably in a fixed sequence, so that the dimensionally accurate pressed part is gradually exposed. The aim here is to avoid stresses in the pressed part by coordinated resetting. The pressing cycle ends with the uncovering of the dimensionally accurate pressed part.

FIG. 3 shows schematically only the process stages 10, 20, 30 and 40 as they can be displayed to a user on a display element of the multi-plate powder press 100 according to the invention. Further process stages can also be displayed on the display element according to the invention. On the display element, individual lower punches 3a1, 3a2, 3a3 of the lower punch arrangement 3a and upper punches 3b1, 3b2, 3b3 of the upper punch arrangement 3b opposite thereto are shown in the same color for simplification purposes, indicated in FIG. 1 by the same hatching, as well as axes x1, x2, x3 defined thereby. The die arrangement 2 is also distinguishable. In stage 10, the reference line or zero point 12 has been established and the respective lower punches 3a1, 3a2, 3a3 have been moved to their zero-point position relative to the reference line 12.

In step 20, the material to be pressed is filled into a mold cavity 14 created by the lower punch assembly 3a and the die 2. Then, in step 20, the upper punches 3b1, 3b2, 3b3 are positioned so that the mold is closed and, in step 30, by moving the punch assemblies 3a, 3b up and down, the filled powder is evenly and optimally distributed in the mold cavity 14. This homogenization of the filled powder takes place without applying pressing force to punches 3a1, 3b1, 3a2, 3b2; 3b3, 3b3. The actual pressing process then takes place in stage 40.

The user can be provided with different information at the display element, for example whether the display is enlarged or reduced, in a clear and easily understandable way. Furthermore, the user can call up further information via elements or directly access the programming.

Shown in FIG. 4 is a schematic flow chart showing the process for producing a dimensionally accurate pressed part and the associated programming. Here, a control program is included, with which a first setting and generation of the actual control program for the press stroke is described, as well as a monitoring of the functions running thereby, whereby it is provided that possibilities for intervention in the sequence in the case of incorrectness and/or for optimization are present.

In a first step, a sequence plan is drawn up and converted into a corresponding control method. For this purpose, a number of mutually adjustable punches 6 and components, in particular comprising a die arrangement 2 and fixed stops 9, are defined, which are moved in a press cycle to be executed in several process stages for the production of a dimensionally accurate pressed part.

In a subsequent step, control parameters are entered. This can be done directly by a user via a control command input element or read in from an assigned data memory. The control parameters include, for example, the number and geometric shape of the adjustable punches 6, their arrangement, their punch path or stroke distance or stroke path, force-path characteristics of the axes involved. Furthermore, data concerning the pressing process, the tools and/or product parameters such as physical properties of the pressable material, tolerances and/or a density distribution to be achieved in the pressed part to be produced can be taken into account and entered via the control command input element. The input can be supported in particular by displaying a variety of operating screens, dialogue boxes and/or messages to a user.

In a subsequent step, a control program is generated which comprises a series of control commands, each control command corresponding to a movement of the defined components. When creating the control program, it is expedient to make use of the control parameters entered.

In a further step, an analysis of the control commands of the generated control program as well as a calculation of the motion of the defined components is performed to determine the movement sequences taking place in the individual process stages for the defined components. This analysis and calculation of the movement can be considered as a kind of simulation, which is advantageously displayed on a display element, for example a screen, for a user to illustrate and visually monitor the individual movement sequences in the individual process stages. Accordingly, the generated control program can be used for a simulation. A plausibility check can be performed already to a certain extent, which prevents definable limit values from being exceeded during the movement sequences.

According to the invention, this analysis of the control commands, the realization of the calculation of the movement of the defined components and the graphic display of the movement sequences take place in real time and in a realistic schematic representation.

Preferably, a test pressing can be carried out according to the generated control program in order to produce a test pressed part. The individual movements calculated by the generated control program are simulated, whereby the results to be measured on the sample pressed part produced in this way can be determined as actual values. When determining actual values on the sample, references can be freely selected, and the actual values can simply be entered without taking into account the preceding sign and any conversion of the order of magnitude. These actual values can be compared with assigned previously defined target values, whereby graphic support is also possible for this. If the determined actual values are outside a tolerance range of the assigned target values, an adjustment of the control program or the control parameters is generated. In particular, a density distribution is determined as an actual value on the test pressed part, which is directly related to a filling level of the compressible material in the mold cavity and/or the weight. A graphic visualization can be used to show how a change in one of the control parameters is reflected in the pressed part to be produced.

The movement sequences of the defined components, in particular of the punching devices 3a, 3b, can be graphically displayed subdivided into the individual process stages. Thus, the movements of the punching devices 3a, 3b can be shown in the start position, during filling, insertion into the mold cavity 14, powder transfer without pressing force, during pressing, pressing force relief, resetting and uncovering, as well as in an end position at the end of the pressing cycle.

In a subsequent step, a transmission of the generated and possibly corrected control program to a numerical control device of the multi-plate powder press 100 takes place.

The control program is then executed in such a way that a dimensionally accurate pressed part is produced in the multi-plate powder press.

1. Multi-plate powder press for producing a dimensionally accurate pressed part from a compressible material, which is fillable into a die, comprising:
a punching device comprising a multitude of punches and components, adjustable relative to one another, in axial and rotational directions, and adjustable relative to a press part,
a drive unit for adjusting the punching device and/or the punches and components, adjustable relative to one another, in and/or counter to a pressing direction, and
a numerical control device which is set up and is programmable in order to control a movement sequence of the punching device and/or the punches and components, adjustable relative to one another, in accordance with a control program,
a control command input element for inputting control parameters, and
a display element adapted to graphically display the punching device and/or the punches and components, adjustable relative to one another, and also movement sequences.

2. Multi-plate powder press according to claim 1, wherein the control command input element is a keyboard and the display element is a screen.

3. Multi-plate powder press according to claim 1, wherein the control command input element and the display element are a touch screen or a smartphone.

4. Multi-plate powder press according to claim 1, wherein during a pressing operation control parameters can be input into the control command input element for a subsequent pressing operation.

5. Multi-plate powder press according to claim 1, wherein an element is provided for wireless transmission of the control program to the numerical control device.

6. Multi-plate powder press according to claim 1, wherein the numerical control device is set up to execute a control program for controlling the punching device and/or the punches and components adjustable relative to one another.

7. Method for controlling a multi-plate powder press, comprising:
Defining a number of punches and components, adjustable relative to one another, comprising at least dies and fixed stops, which are moved in a press cycle in a plurality of process stages for the production of a multi-stage pressed part;
Inputting of control parameters;
Generation of a control program comprising a series of control commands, each command corresponding to a movement of the defined components;
Analyzing the control commands of the generated control program and performing calculations of the movement of the defined components in order to determine movement sequences in the individual process stages of the defined components, whereby said movement sequences are displayed graphically in a realistic schematic representation;
transmission of the control program to a numerical control device; and
Execution of the control program by the numerical control device for the production of a dimensionally accurate pressed part;
wherein the analysis of the control commands, the calculation of the movement of the defined components and the display of the movement sequences are carried out in real time.

8. Method for controlling according to claim 7, said multi-plate powder press comprising a punching device comprising a multitude of punches and components, adjustable relative to one another, in axial and rotational directions, and adjustable relative to a press part, the punching device being graphically displayed in said individual process stages, which correspond to a start position, filling and introduction, powder transfer initially without pressing force action, pressing, pressing force release, resetting and/or uncovering and/or end of a pressing cycle.

9. Method for controlling according to claim 7, wherein a simulation can be carried out with a said generated control program.

10. Method for controlling according to claim 9, wherein geometrical and/or physical parameters are determined on a pressed part produced with the simulation, which parameters are compared as actual values with previously defined target values, the method being set up in order to generate new control parameters from the comparison.

11. Method for controlling according to claim 10, wherein one of the actual values is a density distribution in the produced pressed part.
